(19) United States
(12) Patent Application Publication
(10) Pub. No.: US 2026/0321732 A1
(43) Pub. Date: Oct. 15, 2026

(54) METHOD FOR MANUFACTURING A VEHICLE BATTERY AND SERIES PRODUCTION

(71) Applicant: HELLA GMBH & CO. KGAA, Lippstadt (DE)

(72) Inventors: Bastian Blömeke, Diemelstadt (DE); Melanie Löbel, Lippstadt (DE); Giuseppe Mattina, Lippstadt (DE); Sonja Otholt, Erwitte (DE); Jürgen Reuter, Anröchte (DE)

(21) Appl. No.: 19/466,708

(22) Filed: Feb. 2, 2026

(30) Foreign Application Priority Data
Feb. 3, 2025 (DE) 102025103904.6

(51) Int. Cl. H01M 10/058; B60R 16/033; H01M 10/0525; H01M 50/209; H01M 50/249; H01M 50/267

(52) U.S. Cl. CPC H01M 10/058; H01M 10/0525; H01M 50/209; H01M 50/249; H01M 50/267; B60R 16/033; H01M 2220/20

(57) ABSTRACT

The invention relates to a method for manufacturing a vehicle battery for a vehicle in a series production for manufacturing different variants, which differ in the series production in a spacing geometry of at least one mounting interface for spaced mounting of the vehicle battery in the vehicle. Furthermore, the invention relates to a series production for manufacturing a first variant and a second variant of a vehicle battery.

### CROSS-REFERENCE TO RELATED APPLICATIONS

This application claims the benefit of German Patent Application 10-2025-103-904.6, filed Feb. 3, 2025, the disclosure of which is incorporated by reference in its entirety.

### FIELD OF THE INVENTION

The invention relates to a method for manufacturing a vehicle battery for a vehicle in series production for manufacturing different variants, and to series production.

### BACKGROUND OF THE INVENTION

Vehicle batteries, especially starter batteries, are generally known from the prior art. As a rule, standards specify the shape of the housing and its mounting points. For this reason, within the scope of series production, the same geometry can always be provided for mounting such starter batteries to the vehicle, even for different vehicle models.

Document CN 219226523U, for example, describes a flat vehicle battery that can be fastened to a structure of the vehicle via laterally protruding mounting interfaces for a spaced suspension.

In the design of modern vehicles, however, the installation space for the battery and its mounting in the vehicle is increasingly designed individually. At the same time, a certain type of battery can be suitable for several vehicle models, in particular, from different vehicle manufacturers.

### SUMMARY OF THE INVENTION

It is an object of the present invention to at least partially eliminate the above disadvantages known from the prior art. In particular, it is an object of the present invention to enable series production of the batteries across multiple different vehicle models, in particular, in order to take into account the construction conditions of the respective vehicle model.

The above object is achieved by a method having the features of the current embodiments and by a series production having the features of the current embodiments.

Further features and details of the invention are apparent from the current embodiments, the description, and the drawings. In this context, features and details described in connection with the method according to the invention also apply correspondingly in connection with the series production according to the invention and vice versa, such that reference can always be made reciprocally with regard to the disclosure of the individual aspects of the invention.

According to a first embodiment, a method for manufacturing a vehicle battery in a series production for manufacturing different variants is provided. In series production, the variants differ in the spacing geometry of at least one mounting interface for spaced mounting of the vehicle battery in a vehicle. The method comprises, preferably in the form of method steps:
manufacturing of a first assembly unit with a first housing section of a battery housing for battery cells of the vehicle battery,
manufacturing of a second housing section of the battery housing and a mounting section in order to form a second assembly unit of the vehicle battery, wherein the mounting section corresponds to one of at least two (or more) mounting types for defining the spacing geometry of the respective variant and the second housing section is compatible with each of the mounting types, and
assembling the first assembly unit and the second assembly unit, in particular, with one another and/or into a common component assembly, to complete the vehicle battery.

The series production can comprise the manufacture of multiple vehicle batteries, in particular, of each variant. The vehicle battery is therefore manufactured in particular as part of the series production. In this context, the manufacturing of the first assembly unit and the manufacturing of the second housing section and of the mounting section can be carried out in immediate succession. Preferably, however, multiple first assembly units and multiple second housing sections and mounting sections are first manufactured in order to finally be assembled in each case to manufacture a vehicle battery. After the manufacture of the vehicle battery, the vehicle battery can be installed in the vehicle.

In some embodiments, the variants of the vehicle battery differ solely in the mounting section, i.e., in particular solely in the spacing geometry or in the spacing geometry and in the mounting interface. Each of the variants can be assigned to a specific vehicle type, a specific vehicle model, and/or a specific vehicle manufacturer.

In particular, the mounting types can be understood as types and/or categories of the mounting sections and/or of the spacing geometry of the variants. The respective mounting type of the variant can correspond to a mechanical connection geometry of the vehicle, in particular, of the respective vehicle model. The spacing geometry can, in particular, define the position of the mounting interface relative to the first and/or second housing section and/or the position of the first and second housing sections relative to the vehicle-side mounting interface of the vehicle. For this purpose, the spacing geometry can comprise dimensions and/or distances that define the position. Thereby, the spacing geometry is determined by the mounting section. The spacing geometry can therefore also be described as a mounting geometry of the vehicle battery. The mounting section can be arranged circumferentially around the second housing section during the manufacturing of the second housing section and the mounting section, and/or during the assembling of the first and second assembly units.

The mounting interface can be designed for fastening the vehicle battery to accommodate a fastening means and/or for form-fit, force-fit, and/or material-bonded fastening to a vehicle-side mounting interface of the vehicle. For example, the mounting interface can have an opening through which the fastening means can be passed in order to fasten the vehicle battery to the vehicle structure. Furthermore, the mounting interface can be reinforced, e.g., by metal inserts. This can improve the strength of the mounting interface. It is possible that the mounting interfaces of different mounting types differ in their fastening type, or that the mounting types have the same fastening type. The spaced mounting can be understood in particular as a mounting on the vehicle that comprises a distance between the mounting interface and the first and/or second housing section, in particular, a basic shape of the first and/or second housing section. Preferably, the vehicle battery can be suspended at least in sections from a vehicle structure by the spaced mounting. Each of the mounting types can define the spacing geometry of one of the variants. This means that any number of different mounting types can be provided within the scope of the series production. In particular, each of the variants manufactured or to be manufactured in the series production can be assigned one of the mounting types, in particular, in each case, a different one of the mounting types.

The first and/or second assembly unit can each be manufactured as a connected or unconnected assembly. For example, the second housing section and the mounting section can be manufactured together, e.g., integrally with each other, in order to form a connected assembly. However, it is also conceivable that the second housing section and the mounting section are manufactured separately from each other to form an unconnected kit that is assembled only to complete the vehicle battery. The first and second housing sections can each be manufactured using a plastic injection molding process, preferably in a multi-component plastic injection molding process. Furthermore, the second housing section and/or the mounting section can preferably each be manufactured separately or together in a plastic injection molding process, preferably in a multi-component plastic injection molding process.

The battery cells can be arranged in the first and/or second housing section after the first and/or second housing section is manufactured. Preferably, after assembling the first and second assembly units, the first and second housing sections enclose a battery interior in which the battery cells are arranged.

To ensure that the second housing section is compatible with each of the mounting types of the mounting section, the second housing section can, for example, have an identical shape across all variants. Thus, the geometry of the second housing section can be designed in such a way that the second housing section, in particular, its basic shape, permits an arrangement of different mounting types of the mounting sections without changing the geometry of the second housing section, in particular, with respect to its outer dimensions of the basic shape, with respect to the battery interior and/or with respect to the first housing section.

It has, therefore, been recognized within the scope of the present invention that a high number of identical parts can be achieved for different variants of vehicle batteries and, at the same time, a high degree of design freedom for the required installation space and/or the vehicle-side mounting interface in the vehicle, if a part of the battery housing is designed uniformly across the variants and (only) the mounting section is modified. Due to the compatibility of the second housing section with different mounting types of mounting sections, a large part of the manufacturing of the vehicle battery can also be retained within the series production for manufacturing the different variants. This greatly facilitates the automation of the manufacture of the vehicle battery. In particular, the manufacturing process can thereby be less complex and/or more cost-effective.

It is also conceivable in a method according to an embodiment of the invention that the vehicle battery is a starter battery and/or a lithium ion battery. In particular, the vehicle battery can be a 12V battery. It is further conceivable that the vehicle battery is a solid-state battery. Due to its design as a lithium-ion battery, the battery housing can be compact and, in particular, deviate from standardized dimensions. This means that the vehicle battery can be installed anywhere in the vehicle. For example, a flat battery housing can be positioned under the rear seat bench. Due to the compatibility of the second housing section with mounting types of the different variants, the influence of mounting the vehicle battery in the vehicle on the vehicle design can be maintained.

Furthermore, in a method according to an embodiment of the invention, it may advantageously be provided that the battery housing has a cuboid basic shape, in particular, with a height of less than 80 mm, a width of less than 500 mm, and/or a depth of less than 170 mm. The cuboid basic shape enables a simple and uniform arrangement of the battery cells in the battery housing. This also simplifies the uniformity of the second housing section across the variants. By virtue of the stated dimensions, a low installation space requirement for the vehicle battery can be achieved. In particular, when the vehicle battery is a lithium ion battery, a high power density can be achieved, while at the same time enabling the vehicle battery to be installed in a wide variety of locations in the vehicle to save space.

Furthermore, in a method according to an embodiment of the invention, it may advantageously be provided that the first housing section forms a lid for the battery housing. Preferably, the first and second housing sections are further made of the same material. The lid can, for example, be formed by a flat lid plate that is placed onto the second housing section during assembling of the first and second assembly units. This can simplify the closing of the battery housing during assembling of the first and second assembly units. Furthermore, the battery interior can be shaped in a shell-like and/or trough-like manner by the second housing section. This allows the mounting section to be attached to one side of the second housing section in a flat and/or height-variable manner. Furthermore, the first housing section can have a groove in which the second housing section and/or a seal of the battery interior engage during assembling of the first and second assembly units.

Preferably, in a method according to an embodiment of the invention, it can be provided that, in particular, irrespective of the variant, all battery cells of the vehicle battery and/or a battery management system of the vehicle battery are arranged, preferably fastened, in the second housing section during or immediately after the manufacturing of the second housing section, preferably before the arrangement of the mounting section on the second housing section. In particular, the battery housing forms the common battery housing for all battery cells and/or battery modules. The battery management system can, for example, comprise a printed circuit board and/or a processor for battery management. Thus, the battery cells, the battery management system, and/or the hardware of the battery management system can be identical for all variants and can be manufactured in the same way. The mounting section can form an external modification in order to mechanically connect the battery housing to the vehicle in a variant-specific manner, i.e., depending on the mounting type.

It is further conceivable in a method according to an embodiment of the invention that the mounting section has an adapter structure for forming the spacing geometry of the mounting interface of the mounting types of the mounting section, in particular, wherein the adapter structure extends from the second housing section after assembling the second assembly unit and the first assembly unit. The adapter structure can connect the at least one mounting interface to the second housing section. In this context, the adapter structure can have stiffening elements, e.g., in the form of ribs. The adapter structure makes it easy to individualize the spacing geometry for the respective variant without substantially influencing the first and/or second housing section, particularly with regard to the external shape.

Furthermore, in a method according to an embodiment of the invention, it is conceivable that the adapter structure has a plurality of ribs which extend outwards from the battery housing after completion of the vehicle battery for fastening to a vehicle-side mounting interface of the vehicle, in particular, a spaced vehicle-side mounting interface. The ribs can be flat and/or extend between the mounting interface and the second housing section. Furthermore, a planar extension of the ribs can run parallel to a housing side of the battery housing, in particular, of the first and/or second housing section. The spacing geometry can be defined by means of the ribs. The ribs provide a simple way of customizing the spacing geometry for the respective variant and mounting type by slightly changing the external shape of the ribs.

Furthermore, in a method according to an embodiment of the invention, it may advantageously be provided that the adapter structure is fastened to the second housing section during assembling of the first assembly unit and the second assembly unit, in particular, directly, preferably after the first and second housing sections are joined together. Preferably, the adapter structure and the second housing section are manufactured separately from each other, in particular, in separate manufacturing processes. This means that the second housing section can be manufactured uniformly, for example, in the form of a large-scale series for all variants. The adapter structure can furthermore be manufactured, for example, in the form of a small-scale series for each of the variants. To complete the vehicle battery, the adapter structure can then be fastened to the second housing section, e.g., at an assembly station where the first and second housing sections are also connected to each other. If the adapter structure is fastened to the second housing section after the first and second housing sections are connected to each other, the battery housing can first be closed by connecting the first and second housing sections before the adapter structure is assembled. This allows the first and second housing sections to be assembled and further processed as a modular unit. It may be provided that the adapter structure has a frame, which, at least partially, surrounds the second housing section after assembly, and/or into which the second housing section is inserted, e.g., in a form-fit manner.

Within the scope of the invention, it is furthermore conceivable that the adapter structure is fastened to the second housing section, in particular separately, in a form-fit, force-fit, and/or material-bonding manner. The adapter structure can preferably be adhesively bonded, screwed, and/or welded to the second housing. The adapter structure can be easily joined to the second housing section by fastening the first assembly unit and the second assembly unit during assembling.

Furthermore, in a method according to an embodiment of the invention, it may advantageously be provided that the adapter structure, preferably the mounting section, is formed integrally with the second housing section, in particular, simultaneously and/or jointly, during manufacturing of the second housing section. For example, the adapter structure can be molded onto the second housing section in a plastic injection molding process. Furthermore, the second housing section and the adapter structure can be manufactured in a common mold. The integral design allows to achieve a high strength of the connection between the adapter structure and the second housing section. Furthermore, it can be avoided that the connection of the adapter structure and the second housing section leads to additional tolerances for the design of the vehicle.

Furthermore, in a method according to an embodiment of the invention, it can advantageously be provided that the adapter structure is formed integrally, in particular together with the second housing section, during the manufacture of the second housing section by means of a molding tool into which a detachable interchangeable insert is inserted, which defines the mounting type. The molding tool can comprise, for example, a plastic injection molding tool. The interchangeable insert can be variant-specific and can form an interchangeable part of the molding tool. Thus, the molding tool can comprise a negative mold of the second housing section and the interchangeable insert, a negative mold of the adapter structure. Tooling costs can be reduced by using the molding tool, which is modified for specific variants using the detachable interchangeable insert. At the same time, this enables integral manufacture of the second housing section with the adapter structure in series for each variant.

In the context of the current embodiments, it is furthermore conceivable that the first and second housing sections are connected to each other during assembling of the first and second assembly units, so that the battery housing is closed by the first and second housing sections, wherein a seal is arranged or is present for sealing a gap between the first and second housing sections. The seal can therefore be, in particular, variant-independent. The seal can be designed to run around the inside of the housing, in particular, in a ring-like manner. The seal can form an additional part which is positioned between the first and second housing sections during assembling of the first and second assembly units. Alternatively, the seal can be molded onto the first or second housing section during the manufacturing of the first or second housing section.

According to a further embodiment, a series production for manufacturing a first variant and a second variant of a vehicle battery for vehicles is provided. The series production comprises, preferably in the form of method steps:
carrying out a method according to the current embodiments for manufacturing the first variant, wherein a mounting section of a first mounting type of at least two different mounting types for forming the first variant of the vehicle battery is manufactured and assembled, and
carrying out a method according to the current embodiments for manufacturing the second variant, wherein another mounting section of a second mounting type of the at least two different mounting types for forming the second variant of the vehicle battery is manufactured and assembled.

Thus, a series production according to the current embodiments provides the same advantages as those already described in detail with reference to a method according to the current embodiments. Preferably, the method for manufacturing the first variant and the method for manufacturing the second variant can be carried out repeatedly in series. It may be provided that all first and/or second housing sections for the method are manufactured by a common series production process. For example, the same molding tool with different interchangeable inserts can be used to manufacture all second housing sections during series production. In particular, an individual interchangeable insert can be provided for each variant.

### BRIEF DESCRIPTION OF THE DRAWINGS

The invention is explained in more detail below, with reference to the accompanying drawings. In the figures:

FIG. 1 is a vehicle battery with a mounting section of a first mounting type;

FIG. 2 is a vehicle battery with a mounting section of a second mounting type;

FIG. 3 is a sequence of a method for manufacturing one of the vehicle batteries;

FIG. 4 is a series production for manufacturing a first variant with the mounting section of the first mounting type and a second variant of the vehicle battery with the mounting section of the second mounting type;

FIG. 5 is a vehicle battery in which a second housing section and an adapter structure are manufactured separately;

FIG. 6 is a vehicle battery in which a second housing section and an adapter structure are manufactured integrally;

FIG. 7 is a vehicle with a vehicle battery manufactured by the method; and

FIG. 8 is a vehicle battery with a mounting section for a further mounting type.

### DETAILED DESCRIPTION OF THE CURRENT EMBODIMENTS

In the following description of several exemplary embodiments of the invention, identical reference signs are used to designate the same technical features, even across different exemplary embodiments.

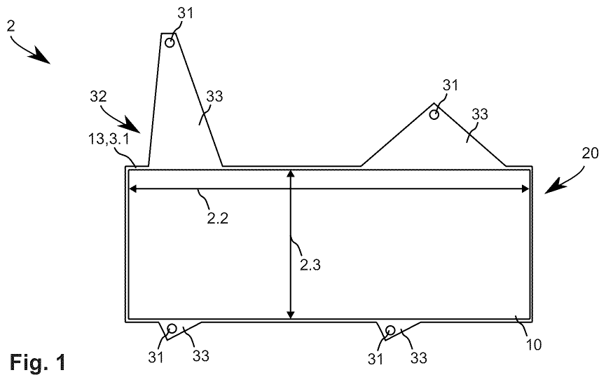

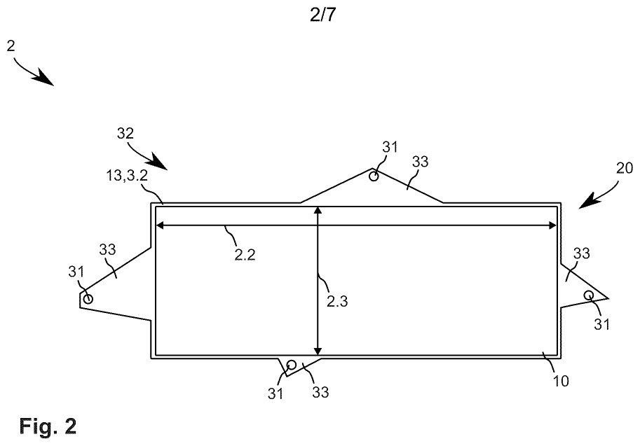

FIG. 1 shows a vehicle battery 2 of a first variant with a mounting section 13 of a first mounting type 3.1, and FIG. 2 shows a vehicle battery 2 of a second variant with a mounting section 13 of a second mounting type 3.2, in each case in a plan view. The variants of the vehicle batteries 2 of FIG. 1 and FIG. 2 differ in the spacing geometry of at least one mounting interface 31 for spaced mounting of the vehicle battery 2 in a vehicle 1.

Preferably, each of the vehicle batteries 2 is a starter battery and/or a lithium ion battery. A battery housing 20 of the vehicle battery 2 can have a cuboid basic shape, in particular, with a height 2.1 of less than 80 mm, a width 2.2 of less than 500 mm, and a depth 2.3 of less than 170 mm, in order to be arranged, for example, under a rear seat of the vehicle 1.

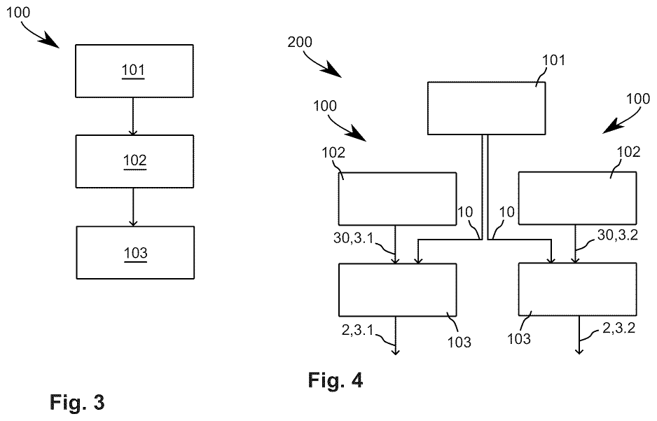

FIG. 4 further schematically shows a sequence of a series production 200 according to the invention for manufacturing the first variant and the second variant. A method 100 for manufacturing the first variant is carried out, in which the mounting section 13 of the first mounting type 3.1 is manufactured and assembled, and a method 100 for manufacturing the second variant is carried out, in which the other mounting section 13 of the second mounting type 3.2 is manufactured and assembled. Each method 100 can be carried out according to the sequence shown in FIG. 3.

In this context, manufacturing 101 of a first assembly unit 10 with a first housing section 12 of the battery housing 20 for battery cells 11 of the vehicle battery 2 is carried out first. Preferably, the first housing section 12 can form a lid for the battery housing 20.

Furthermore, the method 100 includes manufacturing 102 of a second housing section 21 of the battery housing 20 and of the respective mounting section 13 to form a second assembly unit 30 of the vehicle battery 2. The mounting section 13 corresponds to one of at least two or more mounting types 3.1, 3.2, 3.3 in order to define the spacing geometry of the respective variant. The second housing section 21 is furthermore compatible with each of the mounting types 3.1, 3.2, 3.3 of the mounting section 13. Preferably, all battery cells 11 of the vehicle battery 2 and/or a battery management system 14 of the vehicle battery 2 can be secured in the second housing section 21 during or immediately after manufacturing 102 of the second housing section 21, irrespective of the variant.

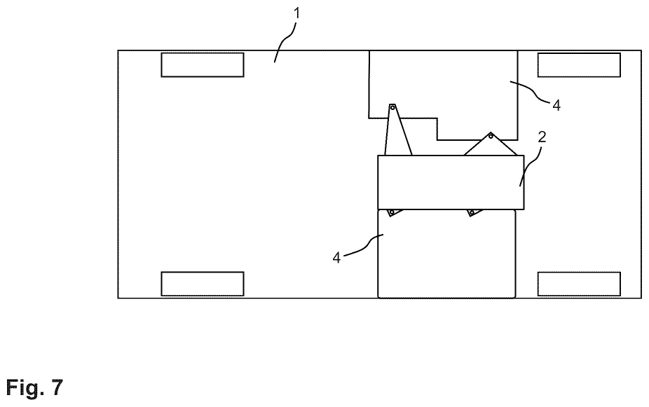

As shown in FIG. 1 and FIG. 2, the mounting section 13 has an adapter structure 32 for forming the spacing geometry of the mounting interfaces 31 of the respective mounting types 3.1, 3.2, 3.3. For this purpose, the adapter structure 32 comprises multiple ribs 33 which extend outwards from the battery housing 20 after completion of the vehicle battery 2 for fastening to a vehicle-side mounting interface 4 of the vehicle 1. The connection of vehicle-side mounting interfaces 4 with the mounting section 13 is shown in FIG. 7.

After manufacturing 101 of the first housing section 12 and manufacturing 102 of the second housing section 21 and of the respective mounting section 13, assembling 103 of the first assembly unit 10 and the second assembly unit 30 is carried out in order to complete the vehicle battery 2. It may be provided that the first and second housing sections 12, 21 are connected to each other during assembling 103 of the first and second assembly units 10, 30, so that the battery housing 20 is closed by the first and second housing sections 12, 21. A seal 22 can be arranged to seal a gap between the first and second housing sections 12, 21.

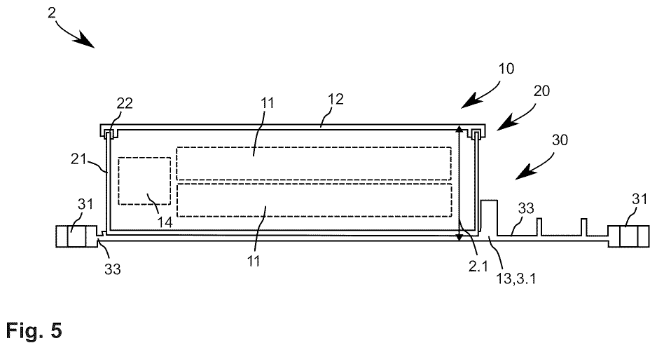

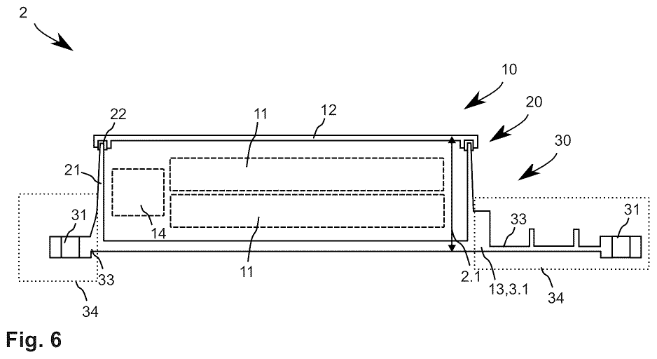

As shown in FIG. 5, the adapter structure 32 to the second housing section 21 can be manufactured separately and fastened to the second housing section 21 during assembling 103 of the first assembly unit 10 and the second assembly unit 30. The adapter structure 32 can then preferably be fastened to the second housing section 21 after the first and second housing sections 12, 21 are joined together. For this purpose, the adapter structure 32 can be fastened separately to the second housing section 21 in a form-fit, force-fit and/or material-bonded manner, for example, during assembling 103 of the first assembly unit 10 and the second assembly unit 30. The second housing section 21 can, for example, be produced identically for all variants in a separate series before the adapter structure 32 is fastened.

As shown in FIG. 6, it may alternatively be provided that the adapter structure 32 is integrally molded with the second housing section 21 during manufacturing 102 of the second housing section 21. For this purpose, the adapter structure 32 can be formed integrally with the second housing section 21, preferably at least partially or completely of the same material, by means of a molding tool, into which a detachable interchangeable insert 34 is inserted, which defines the mounting type 3.1, 3.2, 3.3. To produce the integral composite of the second housing section 21 and the adapter structure 32, the molding tool can, for example, have a part mold that is identical for all variants for forming the second housing section 21.

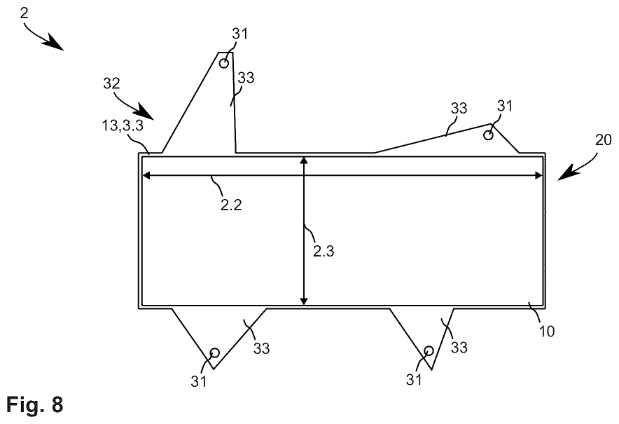

FIG. 8 shows a vehicle battery 2 in which the mounting section 13 corresponds to a further mounting type 3.3. This means that any number of mounting types 3.1, 3.2, 3.3 can be provided, which serve to manufacture the variants during series production 200. For each of the variants, the respective mounting section 13 preferably corresponds to one of the mounting types 3.1, 3.2, 3.3.

The foregoing explanation of the embodiments describes the present invention solely by way of examples. It is understood that individual features of the embodiments can be freely combined with one another, provided this makes technical sense, without departing from the scope of the present invention.

### LIST OF REFERENCE NUMBERS:

1 vehicle
2 vehicle battery
2.1 height
2.2 width
2.3 depth
3.1 first mounting type
3.2 second mounting type
3.3 further mounting type
4 vehicle-side mounting interface
10 first assembly unit
11 battery cells
12 first housing section
13 mounting section
14 battery management system
20 battery housing
21 second housing section
22 seal
30 second assembly unit
31 mounting interface
32 adapter structure
33 ribs
34 interchangeable insert
200 series production
100 method
101 manufacturing of 12 and 30
102 manufacturing of 21 and 13
103 assembling

The above description is that of a current embodiment of the invention. Various alterations and changes can be made without departing from the spirit and broader aspects of the invention. This disclosure is presented for illustrative purposes and should not be interpreted as an exhaustive description of all embodiments of the invention or to limit the scope of the claims to the specific elements illustrated or described in connection with these embodiments. Any reference to elements in the singular, for example, using the articles “a,” “an,” “the,” or “said,” is not to be construed as limiting the element to the singular.

1. A method for manufacturing a vehicle battery in a series production for manufacturing different variants, which differ in the series production in a spacing geometry of at least one mounting interface for spaced mounting of the vehicle battery in a vehicle, comprising:
manufacturing a first assembly unit with a first housing section of a battery housing for battery cells of the vehicle battery,
manufacturing a second housing section of the battery housing and a mounting section in order to form a second assembly unit of the vehicle battery, wherein the mounting section corresponds to one of at least two mounting types for defining a spacing geometry of a respective variant and the second housing section is compatible with each of the mounting types, and
assembling the first assembly unit and the second assembly unit to complete the vehicle battery.

2. The method according to claim 1, wherein the vehicle battery is at least one of a starter battery and a lithium-ion battery.

3. The method according to claim 1, wherein the battery housing has a cuboid basic shape with a height of less than 80 mm, a width of less than 500 mm, and a depth of less than 170 mm.

4. The method according to claim 1, wherein the first housing section forms a lid for the battery housing.

5. The method according to claim 1, wherein arranging all battery cells of the vehicle battery in the second housing section during or immediately after the manufacturing of the second housing section, irrespective of the variant.

6. The method according to claim 1, comprising arranging a battery management system of the vehicle battery in the second housing section during or immediately after the manufacturing of the second housing section, irrespective of the variant.

7. The method according to claim 1, wherein the mounting section has an adapter structure for forming the spacing geometry of the mounting interface of the mounting types of the mounting section, wherein the adapter structure extends from the second housing section after assembling of the first assembly unit and the second assembly unit.

8. The method according to claim 7, wherein the adapter structure has a plurality of ribs, which extend outward from the battery housing after completion of the vehicle battery for fastening to a vehicle-side mounting interface of the vehicle.

9. The method according to claim 7, wherein the adapter structure is fastened to the second housing section during assembling of the first assembly unit and the second assembly unit after the first and second housing sections are connected to each other.

10. The method according to claim 7, wherein the adapter structure is fastened separately to the second housing section in at least one of a form-fit manner, a force-fit manner, and a material-bonded manner during assembling of the first assembly unit and the second assembly unit.

11. The method according to claim 7, wherein the adapter structure is formed integrally with the second housing section during manufacturing of the second housing section.

12. The method according to claim 11, wherein the adapter structure is formed integrally with the second housing section during manufacturing of the second housing section by a molding tool into which a detachable interchangeable insert defining the mounting type is inserted.

13. The method according to claim 1, wherein the first and second housing sections are connected to each other during assembling of the first and second assembly units so that the battery housing is closed by the first and second housing sections, wherein a seal is arranged to seal a gap between the first and second housing sections.

14. A series production method for manufacturing a first variant and a second variant of a vehicle battery for vehicles, comprising
performing the method of claim 1 for manufacturing the first variant, wherein a mounting section of a first mounting type of at least two different mounting types is manufactured and assembled to form the first variant of the vehicle battery; and
performing the method of claim 1 for manufacturing the second variant, wherein another mounting section of a second mounting type of the at least two different mounting types is manufactured and assembled to form the second variant of the vehicle battery;
wherein the second housing section of the battery housing for battery cells of the first variant and the second housing section of the battery housing for battery cells of the second variant are compatible with each of the at least two different mounting types.
